(19) United States
(12) Patent Application Publication
(10) Pub. No.: US 2019/0299924 A1
(43) Pub. Date: Oct. 3, 2019

(54) Occupancy Sensing for a Child Transportation System

(71) Applicant: Suzhou Swandoo Children's Articles Co., Ltd., Suzhou (CN)

(72) Inventors: Nicolas Gonzalez Garrido, Vienna (AT); Vojislav Mokric, Grocka (RS); Stefan Bocvarski, Belgrade (RS)

(21) Appl. No.: 16/298,998

(22) Filed: Mar. 11, 2019

Related U.S. Application Data
(63) Continuation of application No. PCT/CN2017/101456, filed on Sep. 12, 2017.

(30) Foreign Application Priority Data
Sep. 12, 2016 (CN) 201610817633.0
Sep. 12, 2016 (CN) 201621050383.4
Sep. 12, 2016 (CN) 201621050426.9
Sep. 12, 2016 (CN) 201621050502.6

(51) Int. Cl. B60R 22/48; B60N 2/00; B60N 2/28; G01V 3/08

(52) U.S. Cl. CPC B60R 22/48; B60N 2/002; B60N 2/2821; B60N 2/2845; B60R 2022/4858; B60R 2022/4866; B60R 2022/4808; G01V 3/08

(57) ABSTRACT

An occupancy sensor for a seating component of a child transportation system is disclosed. A pair of conductors couple to capacitive sensors. The pair of conductors are coupled to the seating component in the region where the torso of a child would be located when a child was occupying the seating component. The conductors are unshielded in the area near the child's torso and are shielded elsewhere. The conductors can be run on either side of a wall of the seating component, and may be run in recessed channels in the wall. Various signal processing operations can be performed to improve occupancy sensing performance.

### CROSS-REFERENCE TO RELATED APPLICATIONS

This application is a continuation of and claims the benefit of International Patent Application PCT/CN2017/101456, filed on 12 Sep. 2017, which claimed benefit of Chinese Utility Model Patent Application No. 201621050502.6, filed Sep. 12, 2016, now pending; Chinese Utility Model Patent Application No. 201621050383.4, filed Sep. 12, 2016, now pending; Chinese Utility Model Patent Application No. 201621050426.9, filed Sep. 12, 2016, now pending; Chinese Utility Model Patent Application No. 201610817633.0, filed Sep. 12, 2016, now pending; the contents of all of which are incorporated herein by reference in their entireties.

### BACKGROUND

This disclosure relates to the field of vehicles, in particular to an intelligent child safety seat with an in-car temperature monitoring function. This disclosure further relates to methods and systems for determining if a seating component of a child transportation system is occupied by a child.

Automobile child safety seats are also called child restraint systems, are specially designed for children at different ages (or having different weights) and mounted in automobiles and can effectively improve the riding safety of children. The automobile child safety seats can be combined with additional devices such as portable child beds, child baskets, auxiliary seats or collision protectors. Under the condition that an automobile suffers from a collision or slows down suddenly, injuries to children can be relieved by reducing impact force to children and limiting body movement of children, and thus riding safety of children is ensured. With the development of science and technology, the child safety seats are developing towards intelligent child safety seats instead of protecting children simply through the fixing function, however, as for certain existing intelligent child safety seats, when corresponding functions are started, operation of all functional is achieved by turning on switches manually, certain inconvenience is caused in the using process consequentially, and parents have to remember to turn on or turn off a power supply all the time. During actual operation, parents are likely to forget to turn off the power supply sometimes, and consequentially unnecessary electricity waste can be caused; automatic control cannot be achieved, and much inconvenience is caused in the actual life.

### SUMMARY

The examples disclosed herein aim to overcome the defects of the prior art and provide a child safety seat provided with a child monitoring device, the child monitoring device is used for monitoring whether a child exists on the safety seat, and if yes, the whole child monitoring device is started, all functional modules are automatically started simultaneously, and functions of all the functional modules are achieved accordingly.

For achieving the above purpose, the following technical scheme is provided by the utility model: a child safety seat provided with a child monitoring device comprises a base and a basket, wherein the basket is movably connected with the base, the child monitoring device is arranged on the basket and comprises a micro-control unit, a monitoring unit and a prompting unit, and the monitoring unit and the prompting unit are connected with the micro-control unit.

Preferably, the monitoring unit is an infrared sensor or a capacitive proximity sensor.

Preferably, the prompting unit is an LED lamp.

Preferably, the child monitoring device further comprises a communication unit connected with the micro-control unit, and the communication unit is used for sending child seating information and relevant data information monitored by all functional modules to client sides.

Preferably, the child monitoring device further comprises a power management unit which is used for providing a power supply for the child monitoring device.

Preferably, the communication unit comprises a mobile communication unit and a Bluetooth unit.

The utility model has the beneficial effects that the monitoring unit is arranged to monitor whether a child exists on the safety seat, if yes, the whole child monitoring device is started automatically, all the functional modules are started accordingly, and the functions of all the functional modules are achieved. If it is monitored that no child exists on the child safety seat or a child leaves the child safety seat, the child monitoring device is not started or is automatically stopped.

### SUMMARY

All examples and features mentioned below can be combined in any technically possible way.

In one aspect, an occupancy sensor for a seating component of a child transportation system includes a first capacitive sensor comprising a first unshielded conductor coupled to a first area of the seating component in the region where a child's torso would be located.

Embodiments may include one of the following features, or any combination thereof. A second capacitive sensor comprising a second unshielded conductor coupled to the first area. The first and second unshielded conductors run along a surface of the seating component that faces a child seated in the seating component, in the first area. The first and second unshielded conductors run along a surface of the seating component that faces away from a child seated in the seating component, in the first area. A wall of the seating component located in the first area comprises first and second channels, wherein the first and second unshielded conductors run in the first and second channels. The first and second unshielded conductors run longitudinally along the seating component. The first and second unshielded conductors are first and second wires. The first and second unshielded conductors are first and second flat conductive strips. The first and second flat conductive strips are between 5 and 20 cm in length, and between 0.5 and 5 cm in width. The first and second unshielded conductors are formed by weaving conductive thread into a fabric covering used for fitting around the seating component.

Embodiments may further include one of the following features, or any combination thereof. The first and second capacitive sensors provide first and second signal outputs, wherein signal processing is applied to the first and second signal outputs. The signal processing comprises taking an average of the first and second signal outputs to form an average signal output. The average signal output is compared to a predetermined threshold value, to determine whether or not the seating component is occupied by a child. The first output of the first capacitive sensor and the second output of the second capacitive sensor are each compared to a predetermined threshold value, to provide first and second indications of whether the seating component is occupied. A logical AND operation is performed on the first and second indications, to determine if the seating component is occupied. A logical OR operation is performed on the first and second indications, to determine if the seating component is occupied.

Embodiments may further include one of the following features, or any combination thereof. The first and second unshielded conductors are coupled to a remote PCB with first and second IPX wires. The first and second IPX wires are connected to the remote PCB using first and second U.FL connectors. A first center conductor of the first IPX wire is soldered to the first unshielded conductor, and a second center conductor of the second IPX wire is soldered to the second unshielded conductor. The first and second unshielded conductors are spaced apart from each other a distance between 2 cm and 15 cm.

A method of sensing the occupancy of a seating component of a child transportation system including sensing with a first capacitive sensor comprising a first unshielded conductor coupled to a first area of the seating component in the region where a child's torso would be located, sensing with a second capacitive sensor comprising a second unshielded conductor coupled to the first area of the seating component in the region where a child's torso would be located, outputting a first signal by the first capacitive sensor and a second signal by the second capacitive sensor, and processing the first and second signals to provide an indication of whether or not the seating component is occupied by a child

### BRIEF DESCRIPTION OF THE DRAWINGS

FIG. 1 is a structure schematic diagram of a basket of a child safety seat provided with a child monitoring device of the utility model.

FIG. 2 is a structure schematic diagram of a base of the child safety seat provided with the child monitoring device of the utility model.

FIG. 3 is a structure schematic diagram of the child monitoring device of the utility model.

FIG. 4 is a workflow schematic diagram of a monitoring unit of the utility model.

FIG. 5 is a block diagram showing elements of a child transportation system.

FIG. 6 is a block diagram of a PCB in a seating component of a child transportation system providing sensor and communication interfaces.

FIG. 7 is top view of a seating component of a child transportation system

FIG. 8A is cross section through a wall of a seating component of a child transportation system.

FIG. 8B is cross section through a wall of a seating component of a child transportation system.

FIG. 8C is cross section through a wall of a seating component of a child transportation system.

FIG. 8D is cross section through a wall of a seating component of a child transportation system.

### DETAILED DESCRIPTION

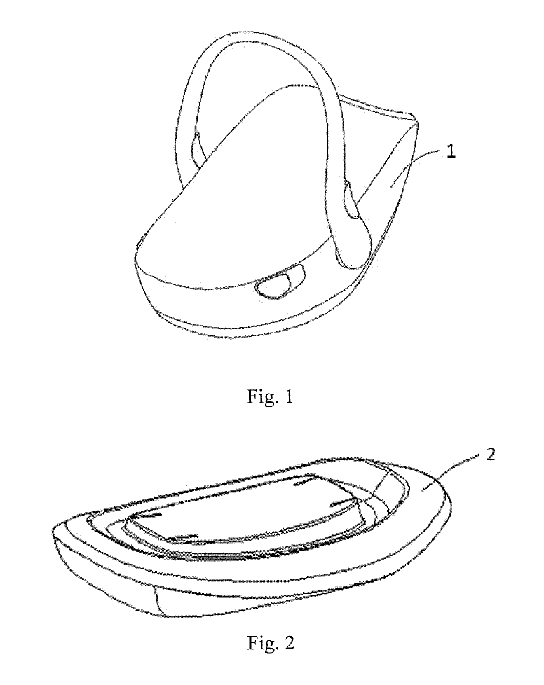

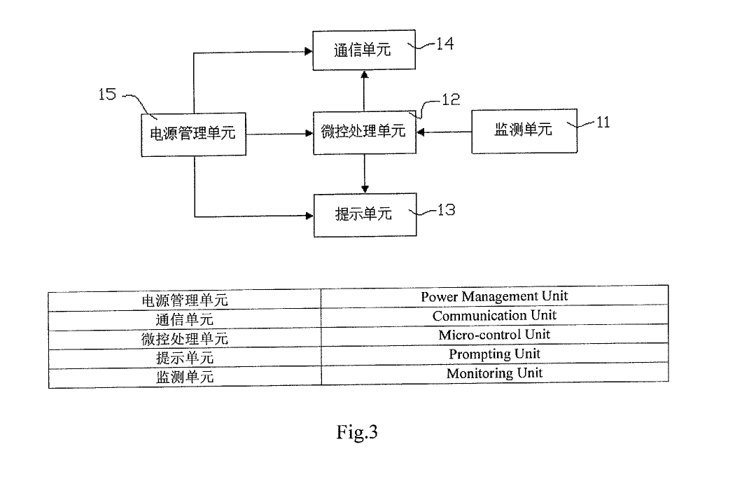

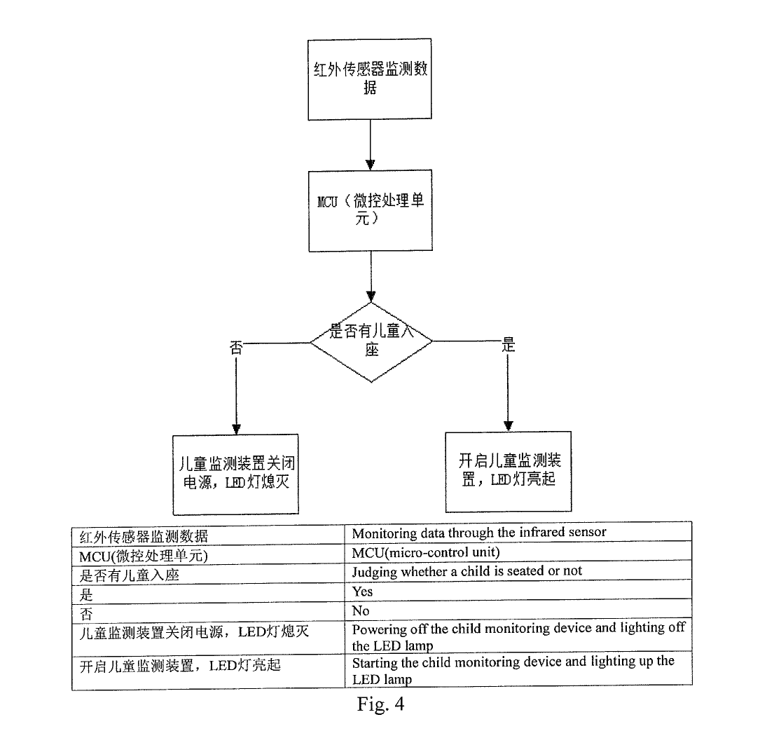

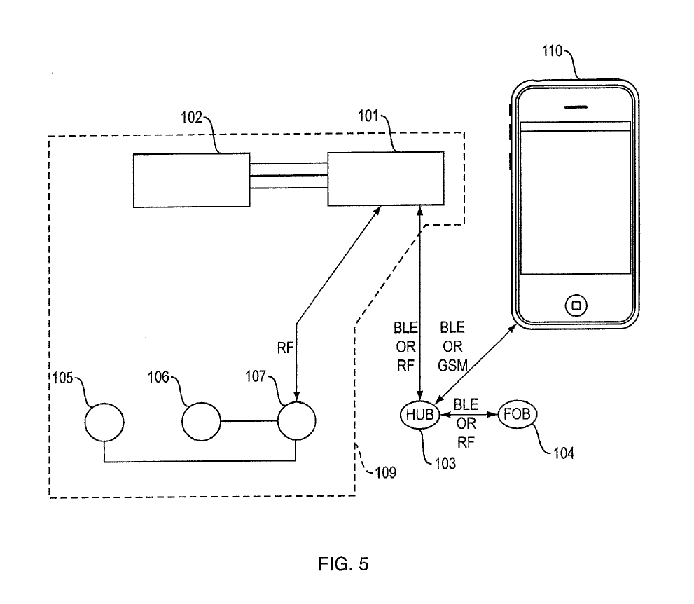

As is shown in FIGS. 1-3, a child safety seat provided with a child monitoring device disclosed by the utility model can be completely intelligent. The child safety seat provided with the child monitoring device comprises a basket 1 and a base 2, wherein the basket 1 can be fixed to the base 2 and can also be lifted independently when necessary; the child monitoring device is arranged on the basket 1 and comprises a micro-control unit 12, a monitoring unit 11, a prompting unit 13, a communication unit 14 and a power management unit 15, and the monitoring unit 11, the prompting unit 13, the communication unit 14 and the power management unit 15 are connected with the micro-control unit 12; the monitoring unit 11 is preferably an infrared sensor, the infrared sensor is used for monitoring whether a child is seated on the child safety seat and sending monitored information data to the micro-control unit 12, and the micro-control unit 12 receives data information of the infrared sensor and sends out a command indicating whether the child monitoring device needs to be started or not; when it is monitored that a child is seated on the child safety seat, the infrared sensor transmits the monitored child seating information to the micro-control unit 12, the micro-control unit 12 receives the child seating information and starts the child monitoring device, all other functional modules connected with the micro-control unit 12 are in the started state, an indicator lamp of the prompting unit 13 lights up at the moment, the indicator lamp is preferably an LED lamp, and it indicates that the whole device is started when the LED lamp lights up. When a child leaves the child safety seat, the infrared sensor sends monitored child leaving data information to the micro-control unit 12, the micro-control unit 12 controls the child monitoring unit to be powered off, the LED lamp lights off, and it indicates that the whole device is powered off.

Specifically, all functional modules connected with the micro-control unit 12 include, but not limited to, a temperature monitoring module (not marked in Figs.), a weight monitoring module (not marked in Figs.) and an inertia monitoring module (not marked in Figs.). When the infrared sensor monitors that a child is seated on the child safety seat, the micro-control unit 12 receives the child seating data information and controls the child monitoring device to be started, the temperature monitoring module is started at the moment, monitors in-car data information and sends the monitored data information to the micro-control unit 12, the micro-control unit 12 stores data and correspondingly computes the data information simultaneously, real-time temperature is displayed on a displayer (not marked in Figs.), whether the in-car temperature exceeds a preset temperature is monitored at the same time, and if yes, corresponding prompt is given out to better guarantee child safety. The weight monitoring module can automatically monitor the child weight and the seat and compute the weight placed on the seat after being started, and then child weight is calculated. The inertia monitoring unit keeps monitoring the vehicle speed in real time in the vehicle traveling process and judges whether a real accident happens or not by calculating the vehicle speed, information is sent to a mobile phone of a preset contact person in time when an accident is monitored, and in this way, family members can better monitor the safety of the child and take emergency measures when necessary. When the child leaves the seat, the infrared sensor monitors that the child leaves the seat and sends child leaving data information to the micro-control unit 12, and the micro-control unit 12 receives the child leaving data information and controls the child monitoring device to be powered off.

The communication unit 14 comprises a mobile communication unit (not marked in Figs.) and a Bluetooth unit (not marked in Figs.), through the mobile communication unit, when an emergency occurs, for example, the inertia monitoring unit monitors that an accident happens, relevant information is sent to preset contact persons on a list in time; if the mobile phone of a first contact person is off, the information is forwarded to a second contact person till the information is successfully sent, and in this way, family members can better learn about the safety of the child conveniently and be informed to take measures in the emergency. When a child is left in a car, the Bluetooth unit can timely remind parents that the child is left in the car, and thus accidents are avoided.

The power management unit 15 is used for charging the whole device and supplementing electric energy, and a wire charging mode or a solar charging mode or other charging modes can be selected.

The child monitoring device of the child safety seat provided with the child monitoring device of the utility model is also suitable for being mounted on child carrying seats such as a baby basket and a baby stroller or other tools, namely the child monitoring device can be arranged on the baby basket or the baby stroller to monitor whether a child exists in the child basket or the stroller, so that the whole device is controlled to be started or stopped, and accordingly all the functional modules of the child safety seat are better controlled.

Child transportation systems disclosed herein perform various operations before, during, and after a vehicle trip has occurred. Prior to a trip, a child transportation system can perform a pre-flight check to ensure that a seating component is present in the vehicle, that a proper seating component is being used (that the child size and weight do not exceed size and weight limits for the seat), that the seating component is occupied, that the seating component is properly and safely installed in the vehicle, that the child is properly secured in the seating component, and that all child transportation system components are functioning properly. Once the pre-flight check is complete, during the trip the child transportation system can monitor itself to ensure all components continue to function properly, the child remains properly secured in the seat, and the seat remains properly secured in the vehicle. Other quantities can be monitored such as environmental variables like temperature and carbon monoxide, and alarms provided or mitigation actions taken if safe levels are exceeded. After the trip is complete, the child transportation system monitors the vehicle to ensure a child (or pet) is not left behind and if dangerous conditions are present to provide alarms and/or take mitigation actions.

When a system check is initiated, whether a pre-flight check initiated manually by a user or system check initiated automatically by the system, an occupancy check is performed. The system checks to see if a child is present in the seating component. The occupancy check uses the system occupancy sensors (described in more detail below), which can be capacitive proximity or optical (IR) technology based sensors, or may be ultrasonic, inductive, magnetic, Hall effect, or pressure based sensors. Any known sense technology useful for determining whether the seat is occupied is contemplated.

If an occupancy condition check performed by the child transportation system fails or a system error occurs, the system user is notified. Occupancy is monitored before, during and at least for a period of time after a trip is complete to make sure a child is not left behind.

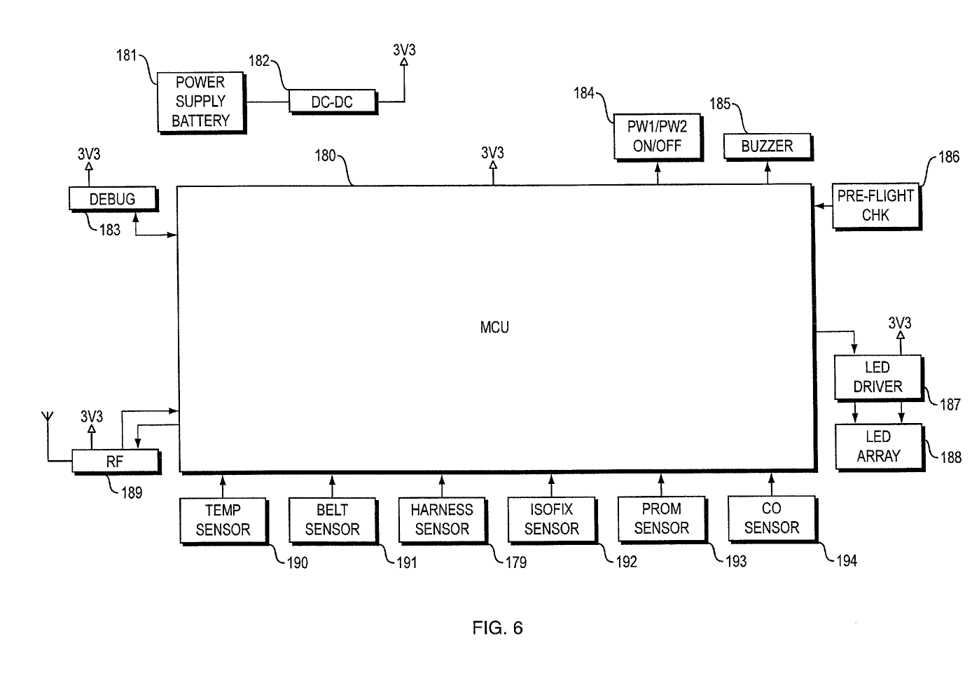

FIG. 5 depicts a block diagram of one non-limiting example child transportation system 100 which includes a number of modules. The components of system 100 that are incorporated on a seating component are surrounded by dotted line 109. PCB 101 and PCB 102 are located on a seating component of the child transportation device (for example seating component 1 of FIG. 1) of child transportation system 100. PCB's 105 and 106 are located on the sides of a seating component of system 100 near routing points for a vehicle lap belt. PCB 107 is located on the rear portion of a seating component of system 100, near routing locations of a vehicle shoulder belt. Hub 103 is arranged to be affixed to a rear window of a vehicle. Key FOB 104 is designed to be carried by a user, as is mobile device 110.

Key FOB 104 wirelessly communicates with hub 103. A single key FOB can be used with more than one seating component so that separate key FOBs are not required for each seating component. A seating component, a hub and a key FOB can come from a factory already paired together so that the user need not perform any pairing operation to initiate communication between the elements.

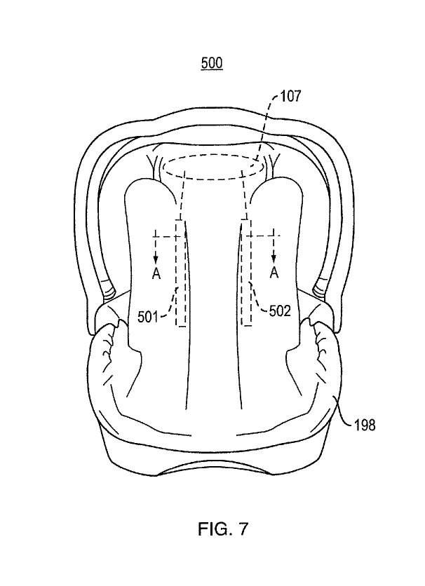

A block diagram of one non-limiting example of PCB 107 is depicted in FIG. 6. PCB 107 includes microprocessor 180 which controls functioning of PCB 107. The power supply of PCB 107 includes battery 181 and DC-DC converter 182. Microprocessor 180 includes I/O interface 184 which is used to control the light output of LED's included on PCB's 105 and 106.

Microprocessor 180 can also control buzzer 185. It should be noted that rather than a buzzer, any device capable of causing an audible output could be controlled by microprocessor 180. The audible output is used to alert the user of a potential problem in the system, whether with the installation of the seat or with the environment in which the seat is located, or with the hardware itself.

In one non-limiting example, a pre-flight check routine can be initiated by a user by actuating a control surface coupled to I/O port 186, by actuating a button on seating component 500, or by interacting with a dedicated system app running on mobile computing device 110. It should also be noted that more than one control surface incorporated in system 100 could be used to initiate the pre-flight check or the pairing operation. For example, a button press on key FOB 104 or taking an action within the dedicated system app. that runs on user's mobile device 110 could also initiate a pre-flight check.

Microprocessor 180 controls LED array 188 through LED driver 187 to provide visual information to the user. Any known display type is also contemplated for use herein.

Microprocessor 180 interfaces with various sensors and switches. Microprocessor 180 is in communication with temperature sensor 190, belt sensors 191, seating component harness sensor 179, Isofix sensors 192, proximity sensors 193, and carbon monoxide (CO) sensors 194. Various sensors may be located on PCB 107 or be connected to PCB 107.

Microprocessor 180 can cause an alarm to be triggered if a sensed quantity exceeds a predetermined threshold, or identifies that a seating component of the system in not installed properly, working properly, of a hazard exists. The alarm can be visual, audible, or both, and may be actuated on various modules of system 100.

Microprocessor 180 can also initiate communication with remotely located mobile device 110 (such as a smartphone, tablet, personal computer and the like) sending a message to remote mobile device 110 that a problem conditions exists. Microprocessor 180 may communicate with a dedicated app. running on mobile device 110. Processor 180 can alert a user of remote mobile device 110 through a dedicated app., and can also describe the condition to the user (for example, that a dangerous temperature is present and also display the temperature). Processor 180 communicates with mobile device 110 via a GSM module incorporated as part of child transportation system 100 (included on another art of system not shown in FIG. 6). Coupling a microprocessor with a GSM module to enable a communication capability over the cellular network is well known and will not be described in further detail here.

CO sensors 194 are used to detect the level of CO present in the ambient environment. Microprocessor 180 compares the detected CO level with one or more pre-determined threshold levels. When the detected level exceeds a predetermined threshold level, the microprocessor triggers an alarm, which may be audible, visual, or both.

Temp sensors 190 are used to measure the temperature present in the ambient environment. Microprocessor 180 compares the measured temperature with one or more pre-determined threshold levels. When the measured level exceeds a predetermined threshold level, the microprocessor triggers an alarm, which may be audible, visual, or both.

Seat belt sensors 191 are located proximate to vehicle seat belt routing structures incorporated as part of seating component of system 100, and are connected via wired connections to PCB 107.

Isofix sensors 192 detect whether or not a seating portion of a system is connected to an Isofix child safety seat base. In one non-limiting example, sensor 192 is a momentary contact switch located on a bottom surface of seating component 500 such that the switch will be closed if the seat is fit into an Isofix base, but will not be closed if seating component rests directly on a vehicle seating surface.

A seating component of a child transportation system may include a harness sensor 179 for measuring the tension in a child harness. In one non-limiting example, shoulder portions of the harness are wound over the end of a cantilevered beam, where applied tension causes the beam to deflect. A strain gauge is mounted on the beam and outputs a signal proportional to applied tension when the beam bends.

In one non-limiting example, proximity sensor 193 is used as an occupancy sensor to detect if the seating component of a system is occupied by a child. In one non-limiting example, capacitive sensor CY8CMBR3102 available from Cypress Semiconductor is configured as a proximity sensor for use as a seating component occupancy sensor. The CY8CMBR3102 IC has a pair of sensor inputs. Both inputs are used, where a sense conductor can be connected to each input. The sense conductors on one end connect to the capacitive sensor IC on PCB 107. The conductors run in an area of the seating component in the region where a child's torso would be located when a child is resting in the seating component, and are coupled to the seating component. The conductors generally run parallel to each other (though other orientations are possible and are described in more detail later), separated by a distance. The conductors are unshielded in the region where they are running in the region where a child's torso would be located when a child is resting in the seating component, and are shielded elsewhere. The conductors are run as close to the child as possible to increase sensor sensitivity.

Capacitive based occupancy sensing has a number of advantages over other sensing methods. Capacitive sensors can sense directly through non-conductive materials such as plastics. This allows the sensors to be buried within the product which protects them from wear and abuse. Capacitive sensors are unaffected by ambient light, unlike IR based sensors. Capacitive sensors are unaffected by stray magnetic fields, which are often present in automotive environments where large currents can flow in wiring harnesses and many electromagnetic devices (i.e. motors) are used.

The “finger capacitance” of a self-capacitance based sensor is proportional to the permittivity of free space, the dielectric constant of overlay material (if present), the area of sensor, and is inversely proportional to distance, as described in the following equation:

CF=(ε0εr A)/D

The “finger capacitance” is the capacitance change sensed when an object gets close to the sensor. It is desirable to maximize CF while minimizing the stray capacitance of the sensor. The permittivity's above are usually set by other considerations in the design, though one can choose the type of overlay material to have a higher permittivity (where in examples disclosed herein the overlay material when present will be the plastic material of a seating component basket wall). It can be seen that maximizing A/D will maximize CF. One cannot arbitrarily increase area, though, as in addition to increasing CF the sensor's sensitivity to noise also increases. In general, applications will require fine tuning to find acceptable tradeoffs. Minimizing D is generally desirable, but the minimum D possible is usually driven by other concerns, such as minimizing direct wear of sense electrodes, as discussed below.

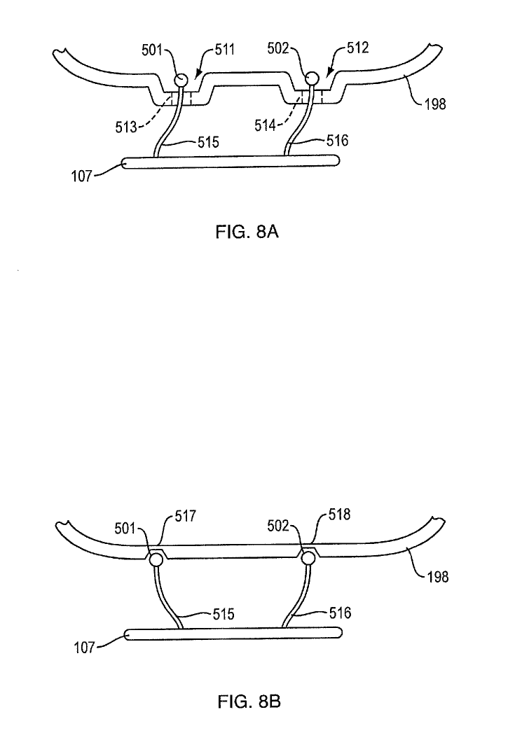

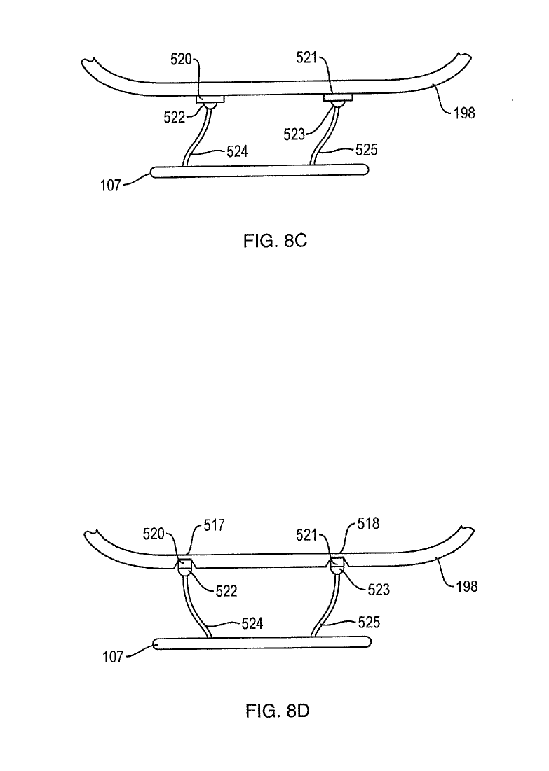

In one non-limiting example depicted in FIG. 7, a top view of seating component 500 is shown. Conductors 501 and 502 run underneath the area where the child rests in basket 198 of seating component 500. FIGS. 8A-8D show various cross sections taken through section A-A of basket 198 of seating component 500, as shown as in FIG. 7. The conductors can be run in a number of ways. As shown in FIG. 8A, in one non-limiting example conductors 501 and 502 can be run in recessed channels 511 and 512 of the inner surface of basket 198, which is the surface that faces the child when the child is seated in the seating basket. Running the conductors as shown in FIG. 8A has the benefit of placing the conductors closer to the child, while protecting them against wear and abrasion by recessing them from the surface, reducing the chances of the conductors becoming damaged. The arrangement of FIG. 8A has the drawback of requiring the wires 501 and 502 to run through penetrations 513 and 514 in the wall of basket 198, in order to connect to PCB 107. In one non-limiting example, conductors 501 and 502 are IPX wires (though other types of wires are contemplated for use herein), where portions 515 and 516 of conductors 501 and 502 are shielded and the portions of conductors 501 and 502 running in channels 511 and 512 are unshielded. Though not shown, connection to PCB 107 may use U.FL connectors.

In one non-limiting example shown in FIG. 8B, the conductors 501 and 502 are run on underside of the seating component basket 198 such that the wall of the basket 198 sits between the conductors and the child. This arrangement further protects the conductors from damage, but reduces sensitivity of the capacitive sensors. In this example, in the regions where the conductors run, the wall of the seating basket (locations 517 and 518) can be reduced in thickness to reduce the sensitivity loss. A benefit of using capacitive based occupancy sensing is that the capacitive sensors do not require that there be wall penetrations in order to sense, sensing can be done right through the wall of basket 198. This is not possible using IR or ultrasonic methods where the wall of basket 198 would block the ability to sense using these methods.

In one non-limiting example depicted in FIG. 8C, the portions of conductors 520 and a 521 running along the rear surface of basket 198 are formed from flat copper strip. The copper strip is easier to attach to the basket surface, and provides increased area for sensing. The copper strip can have one side coated with a pressure sensitive adhesive backing which is used to attach the copper strip to the basket surface. The sections of copper strip 520 and 521 are approximately 10 cm long and 2 cm. wide, though a length anywhere between 5 cm and 20 cm can be used with various sizes of seating components. A longer length conductor may be used for larger seating components accommodating larger children, though this is not required. While a width of 2 cm was chosen in this example, wider or narrower strip can be used effectively as well. Width between 0.5 cm and 5 cm will work well. The copper strip is unshielded. Connection to PCB 107 is made by soldering a center conductor of shielded IPX cable (though other types of wires are contemplated for use herein) to an end of the copper strip. at solder joints 522 and 523. The IPX wire connection from the copper strip sections 520 and 521 to PCB 107 is shielded, reducing stray capacitance of the sense conductors.

In one non-limiting example depicted in FIG. 8D, the portions of wires 520 and a 521 running along the rear surface of basket 198 are also formed from flat copper strip. The sections of copper strip 520 and 521 are approximately 10 cm long and 2 cm. wide. The sections 520 and 521 run in recessed channels to minimize the wall thickness of the wall of basket 198 in the regions 517 and 518 where the copper strip is located. This further reduces the distance “D” between the sensing conductors and the object to be sensed. The copper strip is unshielded. Connection to PCB 107 is made by soldering a center conductor of shielded IPX cable to an end of the copper strip, at solder joints 522 and 523. The IPX wire connection from the copper strip sections 520 and 521 to PCB 107 is shielded, reducing stray capacitance of the sense wires. Though not shown in FIGS. 9A-9D, flat copper strip could be run in recessed channels located on the child facing side of basket 198, as shown for conductors 501 and 502 in FIG. 8A.

The spacing between the unshielded sensing portions of conductors 501 and 502 (and between portions 520 and 521) that are coupled to the seating component in the region where a child's torso would sit is not critical. However, the spacing should not be so great that the conductors sit outside of the torso area of a child to the extent that they would increase “D” and reduce sensor sensitivity, and should not be so close together that the sensor outputs effectively do not differ from each other, as the utility of having a pair of sensors goes down if they are exposed to essentially the same conditions. Generally, spacing should fall in a range greater than 2 cm and less than 15 cm.

In one non-limiting example, conductive thread can be woven in a fabric covering used to cover the seating basket 198 to form conductors for use with capacitive sensors. A snap type connector can be used to connect the conductive portion of the fabric covering to an IPX wire that connects back to PCB 107. By forming the conductive portions of the sensors in the fabric covering, the distance between the sensor conductors and the child to be sensed can be further reduced (reducing “D”) which further improves the sensitivity of the sensors (by increasing CF).

It should be noted that other orientations of conductors can be used and still obtain effective occupancy sensing. Rather than have a pair of straight conductors running lengthwise in basket 198, the pair of conductors could run at an angle to the lengthwise direction. The conductors could even run widthwise across basket 198. The conductors should still be oriented to be generally near the location of the torso of the child in the seat. Additionally, while straight conductors are shown, the conductors could curve. What is desired is that a pair of sensors be used, that they be arranged for good signal to noise ratio, that conductors of the capacitive sensors generally couple to the seating component in the region where a child's torso would be located, and the conductors are spaced apart sufficiently so there is at least some differentiation in their response when a child is present and moves around in the seating component.

The signal outputs of the capacitive sensors can be processed in a number of ways. Various possibilities for applied signal processing are described below. In one non-limiting example, each sensor output is monitored individually. Predetermined thresholds values for signal output are provided such that when the output signal level exceeds the predetermined threshold signal level, a child is determined to be present. The result of the threshold comparison is a two-state output of “child present” and “child not present”. The logical two state outputs can be processed with a logical “AND” operation such that the overall sensing system output will only indicate that a child is present if both individual sensors indicate a child is present. This operation reduces the chances of a false positive occupancy result (indicating a child is present when no child is present), but increases the chance of a false negative.

In one non-limiting example, the two state outputs of the pair of capacitive sensors are processed by a logical “OR” operation, where the occupancy sensing system will determine that a child is present if either capacitive sensor alone indicates a child is present, or if both sensors indicate a child is present. This operation reduces the chances of a false negative occupancy result (indicating a child is not present when a child is present), but increases the chance of a false positive.

In one non-limiting example, the output signals from each capacitive sensor are averaged, and the average level is compared to a predetermined threshold value to determine whether or not a child is present. The seating component is determined to be occupied by a child when the average value exceeds a predetermined threshold value. Averaging the outputs of multiple sensors can be useful in improving the sensor signal to noise ratio, as the signals will typically be correlated in each sensor output while noise will typically be uncorrelated in each sensor output. While a number of signal processing operations have been described, other processing on the pair of sensor outputs may be used if desired, and the examples disclosed herein are not limited by the signal processing applied to the pair of sensor outputs.

In one non-limiting example, rather than using a capacitance based sensing technique to determine occupancy of the seating component, other methods such as optical (IR), ultrasonic, imaging, inductive, magnetic, Hall effect, motion, and pressure sensing are also contemplated herein. Capacitive sensing has an advantage in that it is less easily fooled when an object that is not a child occupies the seating component and it has low cost, low power requirements compared to other sense methods, and high reliability but other methods can be employed to accomplish occupancy detection. It is also possible to combine methods to further improve robustness of the detection.

The foregoing description discloses the technical content and technical characteristics of the utility mode, however, those skilled in the field can still make various substitutes and modifications without deviating from the spirit of the utility model based on demonstrations and disclosures of the utility model, therefore, the protection scope of the utility model is not limited to the content disclosed by the embodiment, and all the substitutes and modifications not deviating from the utility model should be included and within the covering range of the claims of the patent application.

What is claimed is:

1. An occupancy sensor for a seating component of a child transportation system comprising:
a first capacitive sensor comprising a first unshielded conductor coupled to a first area of the seating component in the region where a child's torso would be located.

2. The occupancy sensor of claim 1 further comprising:
a second capacitive sensor comprising a second unshielded conductor coupled to the first area.

3. The occupancy sensor of claim 2 wherein the first and second unshielded conductors run along a surface of the seating component that faces a child seated in the seating component, in the first area.

4. The occupancy sensor of claim 2 wherein the first and second unshielded conductors run along a surface of the seating component that faces away from a child seated in the seating component, in the first area.

5. The occupancy sensor of claim 2 wherein a wall of the seating component located in the first area comprises first and second channels, wherein the first and second unshielded conductors run in the first and second channels.

6. The occupancy sensor of claim 2 wherein the first and second unshielded conductors run longitudinally along the seating component.

7. The occupancy sensor of claim 2 wherein the first and second unshielded conductors are first and second wires.

8. The occupancy sensor of claim 2 wherein the first and second unshielded conductors are first and second flat conductive strips.

9. The occupancy sensor of claim 8 wherein the first and second flat conductive strips are between 5 and 20 cm in length, and between 0.5 and 5 cm in width.

10. The occupancy sensor of claim 2 wherein the first and second unshielded conductors are formed by weaving conductive thread into a fabric covering used for fitting around the seating component.

11. The occupancy sensor of claim 2 wherein the first and second capacitive sensors provide first and second signal outputs, wherein signal processing is applied to the first and second signal outputs.

12. The occupancy sensor of claim 11 wherein signal processing comprises taking an average of the first and second signal outputs to form an average signal output.

13. The occupancy sensor of claim 12 wherein average signal output is compared to a predetermined threshold value, to determine whether or not the seating component is occupied by a child.

14. The occupancy sensor of claim 11 wherein the first output of the first capacitive sensor and the second output of the second capacitive sensor are each compared to a predetermined threshold value, to provide first and second indications of whether the seating component is occupied.

15. The occupancy sensor of claim 14 wherein a logical AND operation is performed on the first and second indications, to determine if the seating component is occupied.

16. The occupancy sensor of claim 14 wherein a logical OR operation is performed on the first and second indications, to determine if the seating component is occupied.

17. The occupancy sensor of claim 2 wherein the first and second unshielded conductors are coupled to a remote PCB with first and second IPX wires.

18. The occupancy sensor of claim 17 wherein the first and second IPX wires are connected to the remote PCB using first and second U.FL connectors.

19. The occupancy sensor of claim 2 wherein the first and second unshielded conductors are spaced apart from each other a distance between 2 cm and 15 cm.

20. A method of sensing the occupancy of a seating component of a child transportation system comprising:
sensing with a first capacitive sensor comprising a first unshielded conductor coupled to a first area of the seating component in the region where a child's torso would be located,
sensing with a second capacitive sensor comprising a second unshielded conductor coupled to the first area of the seating component in the region where a child's torso would be located,
outputting a first signal by the first capacitive sensor and a second signal by the second capacitive sensor,
processing the first and second signals to provide an indication of whether or not the seating component is occupied by a child.
